(19) United States
(12) Patent Application Publication
(10) Pub. No.: US 2006/0100330 A1
(43) Pub. Date: May 11, 2006

(54) Composition for use in forming an article

(76) Inventors: Kavilipalayam M. Natarajan, Holmdel, NJ (US); Stephen Hanley, Lebanon, NJ (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/985,382

(22) Filed: Nov. 10, 2004

(51) Int. Cl. C08K 5/10

(52) U.S. Cl. 524/315

(57) ABSTRACT

A composition for use in forming an article is disclosed and is particularly useful as a bezel in various applications such as headlights, watches, and clocks. The composition generally includes a polyalkylene terephthalate and/or polyester thereof, a lubricant, and a plasticizer. The polyalkylene terephthalate is selected from at least one of poly(butylene terephthalate) (PBT) and poly(ethylene terephthalate) (PET). The lubricant includes an esterification product of a first alcohol and a first acid having an aliphatic and/or an alicyclic chain of at least 20 carbon atoms and is preferably the reaction product of montanic acid and a multifunctional alcohol. The plasticizer includes an esterification product of a polyoxyalkylene alcohol and a second acid having an aliphatic and/or an alicyclic carbon chain. As one example, the plasticizer is the reaction product of montanic acid and a multifunctional alcohol and the polyoxyalkylene alcohol of the lubricant is selected from at least one of polyethylene glycol (PEG) and polypropylene glycol (PPG).

### BACKGROUND OF THE INVENTION

1. Field of the Invention

The subject invention relates to a composition for use in forming an article such that the article has a substantially haze-free surface.

2. Description of the Prior Art

Various articles are known to those skilled in the art as a rim, or a bezel, that typically holds a transparent covering such as a lens for applications including headlights, watches, and clocks. These articles may also generally include lamp reflectors for the headlights. The articles also typically include a metallized surface layer disposed on the article for reflecting light. The metallized surface layer may be disposed directly on the article or a base coat may be applied before the metallized surface layer. U.S. Pat. Nos. 5,865,530 and 5,916,495 disclose lamp reflectors and methods of forming the same. The lamp reflectors are formed of an plastic shell having a substantial portion of inorganic fill material, or filler, with a reflector region having a smooth surface skin with little or no inorganic fill material. A metallized surface layer is formed directly on the reflector region without a base coat being used. The molded plastic shell includes a thermoset molding compound containing an unsaturated polyester resin, styrene, additives, mineral fillers, and glass reinforcements.

Other compositions are also known for producing light-reflecting bodies and are disclosed in U.S. Pat. Nos. 4,429,004 and 4,623,562. The light-reflecting bodies consist of a polyalkylene terephthalate and/or a copolyester thereof, a finely-divided filler, and a light-reflecting metal layer applied directly to at least one surface of the light-reflecting bodies.

Various other compositions are also known to those skilled in the art for forming an article. The compositions generally include a polyalkylene terephthalate and/or polyester thereof and various other fillers, such as lubricants, plasticizers, stabilizers, nucleating agents and the like. One such composition is disclosed in United States Patent Application Publication No. 2004/0152810 which includes an additive to a polyester resin containing a plasticizer having one compound selected from hydroxy aliphatic monocarboxylic acid ester and carboxylic acid amide.

Another composition is disclosed in United States Patent Application Publication No. 2003/0069339 which includes a polybutylene terephthalate (PBT) resin for forming articles. The composition includes a phosphorus-based antioxidant, such as triphenyl phosphite and the like. The phosphorus-based antioxidant is added to the PBT resin to increase the resistance to heat aging of the article. More specifically, the article has reduced deterioration in color tone as a result of the phosphorus-based antioxidant. The composition also includes conventional mold-releasing agents such as polyethylene waxes and silicone oils. The mold releasing agents may be selected from fatty acid esters having a residue group of a fatty acid having 12 to 36 carbon atoms and a residue group of an alcohol having 1 to 36 carbon atoms. One example of the fatty acid includes montanic acid and the alcohol includes monohydric alcohols and polyhydric alcohols.

Still other compositions are disclosed in U.S. Pat. Nos. 4,211,689 and 4,879,355. The '689 patent discloses thermoplastic copolyesters useful in molding resins. The copolyesters are prepared by transesterfication of (a) straight or branched chain poly(1,4-butylene terephthalates) and (b) a polyester of (i) a cycloaliphatic 1,2-dicarboxylic acid or a derivative thereof, and (ii) 1,4-butanediol. The '355 patent discloses a polymer blend including an aromatic polyester having repeat units from terephthalic acid, isophthalic acid and Bisphenol A, a glycol copolyester having repeat units from 1,4-cyclohexanedimethanol, terephthalic acid and an alkylene glycol, and a polycarbonate resin.

The related art articles are characterized by one or more inadequacies such as forming the compositions with plasticizers having short carbon chains. These plasticizers have increased volatility and decreased thermal stabilities thereby increasing degradation of the plasticizer. The increased degradation results in increased haze in the article. It is difficult to adhere a metallized surface layer directly to the article and the metallized surface layer magnifies any flaws, such as haze, within the article. Another inadequacy is that it is costly to include a base coat between the metallized surface layer and the article, which increases the cost of producing the article.

### SUMMARY OF THE INVENTION AND ADVANTAGES

The subject invention provides a composition for use in forming an article, such that the composition results in the article having a substantially haze-free surface. The composition includes a polyalkylene terephthalate and/or polyester thereof, a lubricant, and a plasticizer. The lubricant includes an esterification product of a first alcohol and a first acid having an aliphatic and/or an alicyclic chain of at least 20 carbon atoms. The plasticizer is different than the lubricant and includes an esterification product of a polyoxyalkylene alcohol and a second acid having an aliphatic and/or an alicyclic chain.

One advantage of the subject invention is that the composition forms the article having the haze-free surface. The lubricant is specifically chosen to be compatible with the polyalkylene terephthalate to ensure that the surface remains haze-free while the lubricant also ensures that the article can be removed from a mold without damaging the article. Another advantage of the subject invention is that the composition has improved flow and melt characteristics which improves the quality of the article and reduces the number of articles that are defective. The novel composition does not increase volatility and maintains or improves thermal stabilities thereby decreasing degradation of the plasticizer, which improves the appearance of the article.

When a metal coating is applied to the surface of the article, defects and/or imperfections, such as haze may be visible through the metal coatings. The metal coating may even magnify the defect such that the article is not acceptable. Still another advantage of the subject invention is that since the article has the haze-free surface, the metal coating may be applied directly thereto without using a base coat. Removing this step from the manufacturing process reduces the time and cost of manufacturing such articles.

### DETAILED DESCRIPTION OF THE INVENTION

A composition for use in forming an article is disclosed. The article is particularly useful as a bezel in various applications such as headlights, watches, and clocks. Those skilled in the art recognize that the bezel is a rim that typically holds a transparent covering such as a lens and reflects light emitted from the headlights.

The composition generally includes a polyalkylene terephthalate and/or polyester thereof, a lubricant, and a plasticizer. The polyalkylene terephthalate is preferably selected from at least one of poly(butylene terephthalate) (PBT) and poly(ethylene terephthalate) (PET). However, the polyalkylene terephthalate may also include a blend of polycarbonates with either the PBT or the PET. In the most preferred embodiment, the polyalkylene terephthalate is PBT and/or polyesters thereof.

The polyalkylene terephthalate and/or polyester thereof is present in an amount of greater than 85 parts by weight based on 100 parts by weight of the composition. Preferably, the polyalkylene terephthalate and/or polyester thereof is present in an amount of greater than 90 parts by weight, and most preferably greater than 95 parts by weight, both based on 100 parts by weight of the composition.

The lubricant includes an esterification product of a first alcohol and a first acid having an aliphatic and/or an alicyclic chain of at least 20 carbon atoms. Preferably, the first alcohol includes a multifunctional, or polyfunctional, alcohol. Examples of multifunctional alcohols include dihydric alcohols such as ethylene glycol, propylene glycol, 1,3-propanediol, 1,4-butanediol, 1,6-hexanediol and 1,4-cyclohexanediol; trihydric alcohols such as glycerol and trimethylolpropane; and tetrahydric alcohols such as pentaerythritol and erythritol.

Preferably, the first acid includes an aliphatic monocarboxylic acid free of aromatic compounds. More preferably, the first acid is a fatty acid having a number-average molecular weight of greater than 300. The fatty acid is selected from at least one of montanic acid (octacosanoic acid), arachidic acid (arachic acid, icosanic acid, icosanoic acid, n-icosanoic acid), tetracosanoic acid (lignoceric acid), behenic acid (docosanoic acid), hexacosanoic acid (cerotinic acid), melissic acid (triacontanoic acid), erucic acid, cetoleic acid, brassidic acid, selacholeic acid, and nervonic acid. Each of the above fatty acids has carbon chains of greater than 20 atoms. For example, montanic acid has an aliphatic carbon chain of 28 atoms and arachidic acid has an aliphatic carbon chain of 20 atoms. In the most preferred embodiment, the lubricant includes the reaction product of montanic acid and a multifunctional alcohol. Examples of suitable lubricants include, but are not limited to, Licowax E, Licowax OP, and Licomont 141, each commercially available from Clariant Corp.

The lubricant acts as a release agent such that when the article is formed, it is able to be removed from a mold. However, the lubricant can also negatively impact the gloss of the article. Therefore, the lubricant must be selected such that the lubricant does not degrade during molding, is compatible with the polyalkylene terephthalate, and results in the article having a substantially haze-free surface. For example, it has been experimentally determined that when the lubricant is based on stearates (i.e., having a chain of 18 carbon atoms), the sterates exude out of the surface of the article and have poor thermostability. As another example, when the lubricant is based on polyethylene waxes, the article has a poor surface appearance. Without intending to be bound to theory, it is believed that the lubricant based on stearates or polyethylene waxes are not compatible with the polyalkylene terephthalates. The amount of the lubricant is important to produce the article that satisfies these requirements. Preferably, the lubricant is present in an amount of from 0.1 to 3 parts by weight based on 100 parts by weight of the composition. More preferably, the lubricant is present in an amount of from 0.3 to 1.5 parts by weight, and most preferably from 0.5 to 1.3 parts by weight, both based on 100 parts by weight of the composition.

The plasticizer is different than the lubricant such that different acids and/or alcohols are used to form the plasticizer than are used to form the lubricant. Specifically, the plasticizer includes an esterification product of a polyoxyalkylene alcohol and a second acid having an aliphatic and/or an alicyclic carbon chain. The polyoxyalkylene alcohol is preferably selected from at least one of polyethylene glycol (PEG) and polypropylene glycol (PPG) and is most preferably PEG. However, those skilled in the art recognize that other polyoxyalkylene alcohols, such as polybutylene glycol, may be used with the subject invention.

It is preferred that the second acid has a chain of 19 or fewer carbon atoms and is also preferably free of aromatic compounds. In one embodiment, the second may includes a fatty acid having a branched structure. More preferably, the second acid includes an aliphatic monocarboxylic acid and is selected from at least one of 2-ethylhexanoic acid, 8-methylnonanoic acid (isodecanoic acid), trialkylacetic acid, caproic acid, octanoic acid (1-heptanecarboxylic acid, caprylic acid), decanoic acid (1-nonane carboxylic acid, caprinic acid, capric acid), dodecanoic acid (lauric acid, laurostearic acid, duodecyclic acid), myristic acid (tetradecanoic acid), 1-pentadecanecarboxylic acid (hexadecylic acid, palmitic acid, n-hexadecanoic acid), palmitoleic acid, stearic acid, isostearic acid, oleic acid, elaidic acid, linoleic acid, and linolenic acid. For example, stearic acid has an aliphatic chain of 18 carbon atoms and decanoic acid has an aliphatic chain of 10 carbon atoms. In the most preferred embodiment, the plasticizer includes the reaction product of an aliphatic monocarboxylic acid having a carbon chain of 19 or fewer carbon atoms and at least one of at least one of polyethylene glycol and polypropylene glycol.

The plasticizer impacts the melt flow properties of the composition. The plasticizer is preferably present in an amount of from 0.25 to 3 parts by weight based on 100 parts by weight of the composition. More preferably, the plasticizer is present in an amount of from 0.3 to 2 parts by weight, and most preferably from 0.5 to 1.5 parts by weight, both based on 100 parts by weight of the composition. However, it is to be appreciated by those skilled in the art that the amount of the plasticizer may be reduced while other components compensate for the lower levels of plasticizer.

The composition may also include a phosphorous-based stabilizer. Preferably, the phosphorous-based stabilizer is a phosphite and more preferably, the phosphite is tris(2,4-di-(tert)-butylphenyl)phosphite. However, it is recognized that other phosphorous-based stabilizers may be used with the subject invention. The stabilizer prevents the composition from degrading while forming the pellets and also while forming the article. The stabilizer inhibits the potential ester-ester interchange at higher temperatures between the lubricant and the polyalkylene terephthalate. If the lubricant reacted with the polyalkylene terephthalate, then the lubricant would not be available to release the article from the mold. The phosphorous-based stabilizer is preferably present in an amount of from 0.1 to 0.5 parts by weight, more preferably from 0.15 to 0.3 parts by weight, and most preferably about 0.2 parts by weight, each based on 100 parts by weight of the composition.

The composition may further include a nucleating agent present in an amount of from 0.01 to 1 parts by weight based on 100 parts by weight of the composition. Preferably the nucleating agent is present in an amount of from 0.05 to 0.5 parts by weight, and most preferably 0.1 parts by weight, both based on 100 parts by weight of the composition. The nucleating agent affects the rate of crystallization and when the nucleation agent is used, the article can be molded quicker. Preferably, the nucleating agent is selected from at least one of talc, kaolin, mica, calcium sulfate, and barium sulfate.

A pigment may also be included in the composition. The pigment may include inorganic or organic compounds and may impart a special effect and/or color to article. The pigment may also be dispersed in a carrier matrix, such as a plastic resin, as understood by those skilled in the art. Preferably, the pigment is carbon black pigment. The pigment is present in an amount of from 0.05 to 5 parts by weight, preferably from 0.5 to 3 parts by weight, and most preferably from 0.5 to 1.5 parts by weight, each based on 100 parts by weight of the composition. The amount of the pigment includes the amount of the carrier matrix, if any. Preferably, the pigment is present in an amount of from 10 to 50 wt % based on 100 wt % of the combined pigment and carrier matrix.

One typical process of preparing the composition includes dry blending the components followed by pelletizing to form pellets. The pellets are preferably extruded, but other methods would also suffice to form the pellets. The pellets are then heated and molded into the article. The article may be formed via extrusion processes or injection molding processes. After being removed from the mold, the article has a metal coating disposed on at least one of the surfaces. The metal coating may be applied using standard techniques including, but not limited to, chemical vapor deposition. The article that is formed from the composition has a substantially haze-free surface. It is important that the article has the haze-free surface otherwise the haze may be visible through the metal coating which results in the article being unsatisfactory. More specifically, the metal coating can actually magnify any defect, such as haze, in the article.

The following examples, illustrating the formation of the article according to the subject invention, as presented herein, are intended to illustrate and not limit the invention.

### EXAMPLES

The composition according to the subject invention was formed from the components listed in Table 1 as parts by weight, unless otherwise indicated. Examples 1-5 embody the subject invention, whereas Comparative Example 1 is a control formed only from polyalkylene terephthalate and pigment and Comparative Examples 2 and 3 illustrate compositions formed from non-compatible lubricants.

TABLE 1
Formulations of Composition

| | Example | Example | Example | Example | Example | Comparative | Comparative | Comparative |
|---|---|---|---|---|---|---|---|---|
| Component | 1 | 2 | 3 | 4 | 5 | Example 1 | Example 2 | Example 3 |
| Polyalkylene | 96.2 | 97.2 | 97.2 | 98.7 | 98.5 | 99.0 | 98.7 | 98.7 |
| terephthalate | | | | | | | | |
| Lubricant A | 1.0 | 1.0 | — | — | — | — | — | — |
| Lubricant B | — | — | 0.3 | 0.3 | 0.5 | — | — | — |
| Lubricant C | — | — | — | — | — | — | 0.3 | 0.3 |
| Lubricant D | — | — | — | — | — | — | — | — |
| Plasticizer | 1.5 | 0.5 | 1.5 | — | — | — | — | — |
| Stabilizer | 0.2 | 0.2 | — | — | — | — | — | — |
| Nucleating Agent | 0.1 | 0.1 | — | — | — | — | — | — |
| Pigment | 1.0 | 1.0 | 1.0 | 1.0 | 1.0 | 1.0 | 1.0 | 1.0 |
| TOTAL | 100.0 | 100.0 | 100.0 | 100.0 | 100.0 | 100.0 | 100.0 | 100.0 |

Polyalkylene terephthalate is PBT commercially available as Ultradur from BASF Corporation. Lubricant A is an esterification product of montanic acid with multifunctional alcohols and is commercially available in flake form as Licomont ET 141 from Clariant Corp. Lubricant B is a partial saponified ester of montanic acids and is commercially available in powder form as Licowax OP from Clariant Corp. Lubricants C and D are oxidized polyethylene based lubricants, or waxes, commercially available as Licolub H12 and Licowax PED191, respectively, from Clariant Corp.

The plasticizer is an ethylhexanoic acid diester of polyethylene glycol and is commercially available as Plast 7071 from CP Hall. The stabilizer is tris(2,4-di-(tert)-butylphenyl)phosphite, commercially available as Irgafos 168 from Ciba Chemicals. The nucleating agent is talc and is commercially available as Talc IT. The pigment is 20 wt % carbon black pigment dispersed in PBT, commercially available as BP 880 in PBT from BASF Corporation.

The above compositions underwent a compounding operation as understood by those skilled in the art. The compounding operation dry blends the components together and then compounds the components in a twin screw extruder at a temperature of about 250° C. and 250 revolutions per minute. The twin screw extruder extrudes a product that is cooled, preferably in a water bath, and then the product is pelletized. The pellets are then dried for about 4 hours at 110° C.

The pelletized product is then molded into an article. The article may have various shapes depending upon the application. For example, the pelletized product may be molded into tensile bars to test the tensile properties or may be molded into flexural bars to test the flexural properties. The following tests were conducted on the samples and the according physical properties were determined: viscosity number, melt index in accordance with ASTM D1208, tensile strength in accordance with ASTM D638, elongation in accordance with ASTM D638, flexural strength in accordance with ASTM D790, flexural modulus in accordance with ASTM D790, notched izod in accordance with ASTM D256A, and surface appearance. The surface appearance was tested on a sample plaque having the following dimensions: 4″×6″×⅛″.

The physical properties for each of the Examples are listed below.

TABLE 2
Physical Properties & Appearance

| | Example | Example | Example | Example | Example | Comparative | Comparative | Comparative |
|---|---|---|---|---|---|---|---|---|
| Property | 1 | 2 | 3 | 4 | 5 | Example 1 | Example 2 | Example 3 |
| Melt Index | 76 | 52 | 41 | 35.6 | 37 | 38.7 | 36.3 | 36 |
| Viscosity Number | 103 | 101 | 114 | 115 | 114 | 114 | 114 | 115 |
| Tensile Strength, psi | 8000 | 8300 | 7400 | 8040 | 8020 | 8200 | 8065 | 8059 |
| Tensile Elongation | 15 | 12.3 | 180 | 190 | 134 | 123 | 156 | 220 |
| at break, % | | | | | | | | |
| Flexural strength, psi | 11500 | 12360 | 10500 | 12300 | 12000 | 12400 | 12300 | 12300 |
| Flexural Modulus, Kpsi | 320 | 350 | 306 | 360 | 359 | 367 | 364 | 365 |
| Notched Izod impact | 0.62 | 0.62 | 0.9 | 0.9 | 0.8 | 0.8 | 0.9 | 0.8 |
| strength, ft · lbs/in. | | | | | | | | |
| Surface appearance | Good | Good | Very Good | Good | Good | Fair | poor | poor |

Comparative Example 1 was formed only from the PBT and without any lubricants or plasticizers to act as a control. The physical properties of each of the Examples and the Comparative Examples were sufficient. Those skilled in the art shall recognize that Examples 1 and 2 have a lower tensile elongation at break as a result of the nucleating agent being added. The nucleating agent helps to improve molding and cycle time, but impacts the physical properties of the samples. Therefore, Examples 3-5 having a higher tensile elongation at break since no nucleating agents were used.

A surface appearance is determined to be very good if it has little or no haze. Haze is understood by those skilled in the art to be areas on the surface that appear to be dull relative to the remainder of the surface. Therefore, a very good appearance may have 1 or no dull areas. A good appearance may have 2-3 dull areas and a poor appearance has 4 or more dull areas. A fair appearance results when there are no dull areas, or haze, but there are other imperfections, such as scratches or rough spots. Without intending to be bound to theory, it is believed that the haze results from the lubricant not being compatible with the PBT. In Examples 1-5, the lubricant is based on montanic ester, which is compatible with PBT, and the surface appearance is either good or very good. Whereas, in Comparative Examples 2 and 3, the lubricant is based on polyethylene and the surface appearance is poor. The poor surface appearance occurs because the polyethylene based lubricant is not compatible with the PBT. The surface appearance of the Comparative Example 1, the control without any lubricant, was fair. The surface appearance of the control had scratches and rough spots that occurred while being removed from the mold.

Obviously, many modifications and variations of the present invention are possible in light of the above teachings. The invention may be practiced otherwise than as specifically described within the scope of the appended claims.

1. A composition comprising:
a polyalkylene terephthalate and/or polyester thereof;
a lubricant comprising an esterification product of a first alcohol and a first monocarboxylic fatty acid having a number-average molecular weight of greater than 300 and having an aliphatic and/or an alicyclic chain of at least 20 carbon atoms;
a plasticizer different than said lubricant and comprising an esterification product of a polyoxyalkylene alcohol and a second monocarboxylic acid having an aliphatic and/or an alicyclic chain of 19 or fewer carbon atoms:
wherein said lubricant is present in an amount of from 0.1 to 3 parts by weight and said plasticizer is present in an amount of from 0.25 to 3 parts by weight, both based on 100 parts by weight of said composition for forming an article having a substantially haze-free surface.

2. A composition as set forth in claim 1 wherein said polyalkylene terephthalate is selected from at least one of poly(butylene terephthalate) and poly(ethylene terephthalate).

3. A composition as set forth in claim 1 wherein said polyalkylene terephthalate is poly(butylene terephthalate) and/or polyester thereof.

4. A composition as set forth in claim 1 wherein said polyalkylene terephthalate and/or polyester thereof is present in an amount of greater than 85 parts by weight based on 100 parts by weight of said composition.

5. A composition as set forth in claim 1 wherein said polyalkylene terephthalate and/or polyester thereof is present in an amount of greater than 90 parts by weight based on 100 parts by weight of said composition.

6. A composition as set forth in claim 1 wherein said first alcohol comprises a multifunctional alcohol.

7. (canceled)

8. (canceled)

9. A composition as set forth in claim 1 wherein said fatty acid is selected from at least one of montanic acid, arachidic acid, tetracosanoic acid, behenic acid, hexacosanoic acid, melissic acid, erucic acid, cetoleic acid, brassidic acid, selacholeic acid, and nervonic acid.

10. (canceled)

11. (canceled)

12. A composition as set forth in claim 1 wherein said second acid comprises a fatty acid having a branched structure.

13. (canceled)

14. A composition as set forth in claim 1 wherein said second acid is selected from at least one of 2-ethylhexanoic acid, 8-methylnonanoic acid, trialkylacetic acid, caproic acid, octanoic acid, decanoic acid, dodecanoic acid, myristic acid, 1-pentadecanecarboxylic acid, palmitoleic acid, stearic acid, isostearic acid, oleic acid, elaidic acid, linoleic acid, and linolenic acid.

15. A composition as set forth in claim 1 wherein said polyoxyalkylene alcohol is selected from at least one of polyethylene glycol and polypropylene glycol.

16. (canceled)

17. A composition as set forth in claim 1 further comprising a phosphorous-based stabilizer.

18. A composition as set forth in claim 17 wherein said phosphorous-based stabilizer is a phosphite.

19. A composition as set forth in claim 18 wherein said phosphite is tris(2,4-di-(tert)-butylphenyl)phosphite.

20. A composition as set forth in claim 17 wherein said phosphorous-based stabilizer is present in an amount of from 0.1 to 0.5 parts by weight based on 100 parts by weight of said composition.

21. A composition as set forth in claim 1 further comprising a nucleating agent present in an amount of from 0.01 to 1 parts by weight based on 100 parts by weight of said composition.

22. A composition as set forth in claim 21 wherein said nucleating agent is selected from at least one of talc, kaolin, mica, calcium sulfate, and barium sulfate.

23. A composition as set forth in claim 1 further comprising a pigment present in an amount of from 0.05 to 5 parts by weight based on 100 parts by weight of said composition.

24. A composition as set forth in claim 1 wherein said polyalkylene terephthalate is poly(butylene terephthalate) and/or polyester thereof.

25. A composition as set forth in claim 24 wherein said lubricant comprises the reaction product of montanic acid and a multifunctional alcohol.

26. A composition as set forth in claim 25 wherein said plasticizer comprises the reaction product of said second monocarboxylic acid and at least one of at least one of polyethylene glycol and polypropylene glycol.

27. (canceled)

28. (canceled)

29. A composition as set forth in claim 26 wherein said polyalkylene terephthalate and/or polyester thereof is present in an amount of greater than 85 parts by weight based on 100 parts by weight of said composition.

30. An article having a substantially haze-free surface, said article comprising the reaction product of:
a polyalkylene terephthalate and/or polyester thereof;
a lubricant comprising an esterification product of a first alcohol and a first aliphatic monocarboxylic fatty acid having a chain of at least 20 carbon atoms; and
a plasticizer different than said lubricant and comprising an esterification product of a polyoxyalkylene alcohol and a second monocarboxylic acid having an aliphatic chain of 19 or fewer carbon atoms,
wherein said lubricant is present in an amount of from 0.1 to 3 parts by weight and said plasticizer is present in an amount of from 0.25 to 3 parts by weight both based on 100 parts by weight of said composition, for forming said article having a substantially haze-free surface.

31. An article as set forth in claim 30 wherein said polyalkylene terephthalate is selected from at least one of poly(butylene terephthalate) and poly(ethylene terephthalate).

32. An article as set forth in claim 30 wherein said first alcohol comprises a multifunctional alcohol.

33. (canceled)

34. An article as set forth in claim 30 wherein said first acid is selected from at least one of montanic acid, arachidic acid, tetracosanoic acid, behenic acid, hexacosanoic acid, melissic acid, erucic acid, cetoleic acid, brassidic acid, selacholeic acid, and nervonic acid.

35. (canceled)

36. An article as set forth in claim 30 wherein said polyoxyalkylene alcohol is selected from at least one of polyethylene glycol and polypropylene glycol.

37. An article as set forth in claim 30 further comprising a nucleating agent selected from at least one of talc, kaolin, mica, calcium sulfate, and barium sulfate.

38. An article as set forth in claim 30 wherein said polyalkylene terephthalate is poly(butylene terephthalate) and/or polyester thereof.

39. An article as set forth in claim 38 wherein lubricant comprises the reaction product of montanic acid and a multifunctional alcohol.

40. An article as set forth in claim 39 wherein said plasticizer comprises the reaction product of an aliphatic monocarboxylic acid having a carbon chain of 19 or fewer carbon atoms and at least one of at least one of polyethylene glycol and polypropylene glycol.

41. An article as set forth in claim 30 further comprising a phosphorous-based stabilizer.

42. An article as set forth in claim 41 wherein said phosphorous-based stabilizer is tris(2,4-di-(tert)-butylphenyl)phosphite.

43. An article as set forth in claim 41 wherein said phosphorous-based stabilizer is present in an amount of from 0.1 to 0.5 parts by weight based on 100 parts by weight of said composition.

44. An article as set forth in claim 30 further comprising a metal coating applied to a surface of said article.
